(19) United States
(12) Patent Application Publication
(10) Pub. No.: US 2004/0260587 A1
(43) Pub. Date: Dec. 23, 2004

(54) Distribution network and convertible packaging system

(76) Inventor: Harry John Vanduyne, Bangkok (TH)

Correspondence Address: LAW OFFICE OF DUNCAN PALMATIER, 530 SOUTH ASBURY, SUITE 5, MOSCOW, ID, 83843, US

(21) Appl. No.: 10/871,492

(22) Filed: Jun. 18, 2004

Related U.S. Application Data
(60) Provisional application No. 60/480,491, filed on Jun. 20, 2003.

(51) Int. Cl. G06F 17/60

(52) U.S. Cl. 705/7

(57) ABSTRACT

A product packaging system includes a packaging element for receiving a first product, wherein the packaging element is fabricated from a convertible commodity. The first product is selected in combination with the selection of the packaging convertible commodity. The packaging convertible commodity is delivered to an end destination. The selection of the first product in combination with selecting the convertible commodity is embodied in an Optimization Program. More preferably the Optimization Program is executable by a computer. Also disclosed is a product packaging tray which can be stacked without need for an outer carton. A tray enclosure can be provided with a means for regulating and controlling the environment within it. The packaging system optimizes the use of packaging as a product and the shipped airspace. The packaging system also includes a packaging material in a form that can be employed in a wide variety of end uses as a product instead of a waste, without extensive reprocessing or recycling. The packaging system additionally provides a tracking means for product distribution and transfer from the grower or manufacturer to the end user or consumer within a value managed quality assurance system.

### CROSS REFERENCE TO RELATED APPLICATION

This application claims priority under 35 U.S.C. §119(e) from provisional patent Application No. 60/480,491, filed Jun. 20, 2003. The 60/480,491 Application is incorporated herein by reference.

### FIELD OF THE INVENTION

The invention relates to a system for a convertible packaging, and more particularly to a packing system that optimizes the selection and distribution of a packing material for protecting a first product in transport. The packing material is ultimately convertible into a second product.

### BACKGROUND OF THE INVENTION

The efficient transport and distribution of products from the grower or manufacturer to the retailer and consumer is a global enterprise of enormous scale and scope. The economies of nations rely on time tested methods that push a product from its point of generation to a location where it can be used, consumed or purchased by a consumer. In the past, single products were usually shipped in packaging with little regard for the fate of that packaging. Little thought was given to supplying packaging as a second product. There were exceptions to this practice. In the early 1900's, Henry Ford required engines for his famous Model “T” automobile to be shipped to his assembly plant in pine boxes with very specific dimensions. The box was not discarded but employed to form seats of the automobile. This was a revolutionary idea. This practice of using packaging as a second product helped to make the Model “T” affordable to the growing American middle class and made the Model “T” more profitable.

Applications of Ford's package and product method are limited to special instances like his Model “T” seats. Similar examples that fail are much more numerous. Many homes have saved coffee cans for use as containers but the recent repackaging of coffee into compact bags as a cost saving practice found few consumers eager to purchase the more expensive canned coffee just for the added benefit of the reusable container.

FIG. 1 shows a conventional logistics and distribution method, demonstrating in an illustration the normal or conventional process of moving product from an exporting market using packaging, cartons and pallets before shipment in containers for sea freight to the destination export market. There the shipment is received, unloaded, broken down and redistributed to another facility for distribution to wholesalers, retailers and consumers. The packing materials and pallets often result in waste, and these materials often end up going through a recycling process and adding costs. In addition, there may also be significant added product loss and damage. For example, typical practice in New Zealand is shown in the left column. Grower 1 601 delivers a product to a packing house 605. At the packing house 605, the product is palletized 604 and packaging costs 608 are incurred. If the product is a perishable food product, such as apples, the product will be precooled and stored 609. To prepare the product for shipping 614, it is containerized 611. The product reaches an importer 616, where the product must be stored 618. From the importer, the product is transferred to a wholesaler 619, and additional storage costs 621 are incurred. The product reaches the retailer 622, who again must incur storage costs 624. After the product reaches the final consumer 625, the packaging must be disposed of as waste 627, often incurring levies and recycling costs. The right column shows a typical U.S.A. method, which is similar.

To be employed is a similar manner to the Model “T” engine box, the manufacturer of the package is provided with a package specification that cannot change, even if required to accommodate necessary changes in variables like the seat's size or shape, or the size of the engine that the box must contain. Henry Ford's method fails in today's global economy because the packaging industry is too mammoth and high volume to change the specification on the packaging for each order, to suit some special need of a particular end user or consumer. However, a system to achieve a broader use for specific packaging materials employed with certain types of products could take Henry Ford's idea into the next century. A need exists for a system that coordinates the use of packaging as a product on a potentially global scale. Instead of packaging as a second product, waste reduction and recycling is a marching cry of today's product packaging industry. The minimizing of packaging reduces the burden of disposal on the end user when the packaging has no other use or value. Recycling is an important first step to slow the flow of rubbish that could be reintroduced as packaging. However, these strategies are flawed. When taken to an extreme, the minimizing of packaging results in no packaging at all. As packaging is reduced, streamlined and cut out, precious protection for the product is sacrificed, but overall cost reductions are very illusive. Transport damage increases with each structural element shaved from the packaging to save another ounce or penny of material for the sake of waste reduction. At best there is usually a catchup situation. Recycling also has problems. Recycling is expensive because of the enormous effort that needs to be expended to collect and segregate waste streams, to reprocess the recycled material and to retool industry to better accommodate the process. It may also lead to unwanted stockpiles of recycled materials that cannot be readily processed. A packaging system is needed that provides a packaging material that can be employed in a variety of end uses as a product rather than a waste, without extensive reprocessing or recycling

Additionally, quality assurance to the consumer is a difficult responsibility in the conventional distribution of products. Currently, the grower or manufacturer has an almost impossible task when attempting to provide the best possible product. They must reconstruct damaging events along the distribution chain that prevented their produce's high quality from reaching the consumer. A system is needed that provides a tracking and control means for the quality assurance for product distribution and transfer from the grower or manufacturer to the end user or consumer.

### SUMMARY OF INVENTION

According to the present invention a packaging system is provided that includes a packaging element for receiving a first product. The packaging element is fabricated from a convertible commodity. The first product is saleable if transported to a first destination. The convertible commodity is also saleable as a second product at a second destination. Additionally, the convertible commodity can be selected from one of a multiple of convertible commodities. A selection means is employed for selecting the first product in combination with selecting the convertible commodity. The selection means is employed to ultimately render the convertible commodity, in the form of the packaging element, saleable at the second destination.

An advantage of the invention is a packaging system that enables the suspension of costs from the producers to the consumers or end users. According to a preferred embodiment of the present invention, the selection means for selecting the first product in combination with selecting the convertible commodity is embodied in an optimization program.

Also, according to a preferred embodiment of the present invention, an optimization program is included in a computer and executable by a computer.

According to another preferred embodiment of the present invention, the second destination for the convertible commodity is not defined.

According to yet another preferred embodiment of the present invention, the packaging element containing the first product is stacked to comprise an enclosure. The enclosure is provided with a means for regulating and controlling the environment within it.

According to one aspect of the present invention, the packaging system optimizes the use of packaging as a product.

According to another aspect of the invention, the packaging system includes a packaging material in a form that can be employed in a variety of end uses as a product rather than a waste, without extensive reprocessing or recycling.

According to yet another aspect of the invention, the packaging system provides a tracking and controlling means for product distribution and transfer from the grower or manufacturer to the end user or consumer.

The invention will be better understood by reference to the following detailed description taken together with the accompanying drawings.

The process disclosed here reduces packaging needs and involves the use of specially designed and reusable trays to facilitate the packaging and shipment of fresh fruit without the need of conventional boxes. The disclosed method, which does not require the need for costly corrugated boxes, reduces packaging costs in a number of ways, including the following:

a. fruit can be shipped in M3 designed trays with no loss of quality without the need of costly boxes;

b. the disclosed trays can be reused an undetermined number of times;

c. volumetric efficiency is obtained from using the disclosed trays when transporting fresh fruit as the trays require less stacking space thereby allowing more product to be stacked and shipped in the same space as conventional boxes; and

d. the disclosed trays can be made from agricultural bi-products of which the tray materials can be formulated to have a second use value at the receiving end, especially on trans-oceanic shipments. Tray material components can be formulated from agricultural bi-products to have a specific carbohydrate and protein percent which can then be mixed in feed rations for poultry, swine, livestock or farm raised fish.

### BRIEF DESCRIPTION OF DRAWINGS

FIG. 1 is a schematic block diagram of a conventional logistics and distribution method.

FIG. 2 is a schematic block diagram of a system, according to an embodiment of this invention, illustrating the inputs into the Broker Optimization Program.

FIG. 3 is a schematic block diagram of a system, according to an embodiment of this invention, illustrating the inputs into the Broker Optimization Program.

FIG. 4 is a schematic block diagram of a system according to an embodiment of this invention.

FIG. 5 is a perspective view of an apple shelving, according to an embodiment of this invention.

FIG. 6 is a plan view of an apple shelving, according to an embodiment of this invention.

FIG. 7 is a first end view of an apple shelving, according to an embodiment of this invention.

FIG. 8 is section 6-6 of the apple shelving of FIG. 6, according to an embodiment of this invention.

FIG. 9 is section 7-7 of the apple shelving of FIG. 6, according to an embodiment of this invention.

FIG. 10 is a second end view of an apple shelving, according to an embodiment of this invention.

FIG. 11 is a section 9-9 of the apple shelving of FIG. 6, according to an embodiment of this invention.

FIG. 12 is a section 10-10 of the apple shelving of FIG. 6, according to an embodiment of this invention.

FIG. 13 is a first end view of three nested apple shelves, according to an 10 embodiment of this invention.

FIG. 14 is a partially sectioned end view of four stacked apple shelves with an apple, according to an embodiment of this invention.

FIG. 15 is a perspective view of continuous perforated apple shelves, according to an embodiment of this invention.

FIG. 16 is a perspective view of a controlled atmospheric pallet enclosure including the apple shelves, according to an embodiment of this invention.

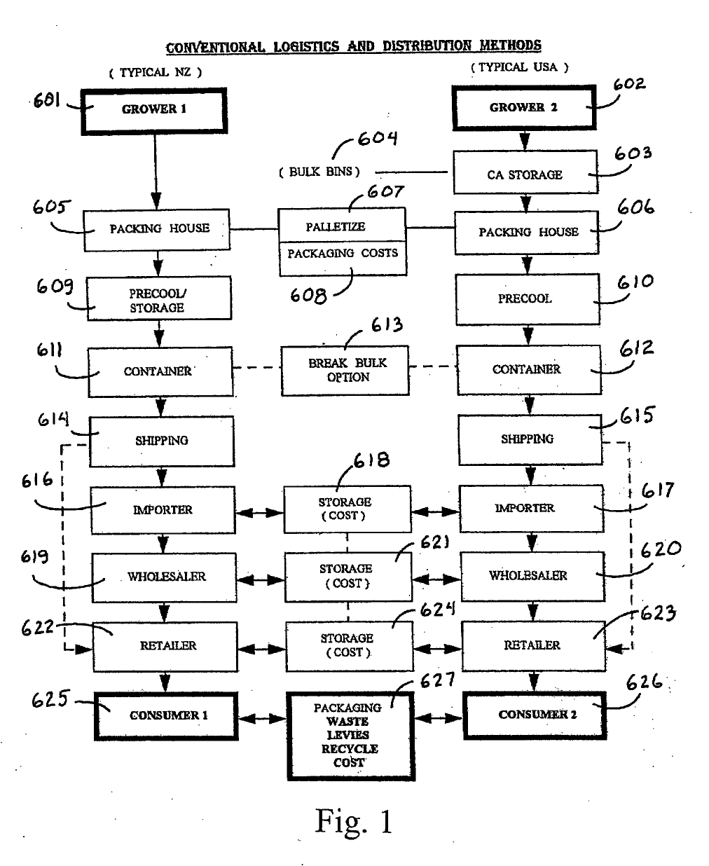

### DETAILED DESCRIPTION OF SPECIFIC EMBODIMENTS

The invention provides a packaging system for transporting a first product contained within a packaging material, where the packaging material is also desired as a second product. The first product and the packaging material second product require a computer based optimization program to automatically select, prepare, route, transport and distribute the first product and the packaging material to specific locations to achieve the most profitable, economical, ecologically sound and time saving distribution of the combined first product and second product.

The packaging system includes a packaging element for receiving the first product. The packaging element comprises the second product. The packaging element's features often depend upon the selection of the first product. The first product may consist of a perishable food item or an item of manufacture. The first product is preferably a perishable food item. The packaging element for such a perishable first product can be designed to protect the individual pieces of the perishable food item and provide adequate ventilation during storage and transport.

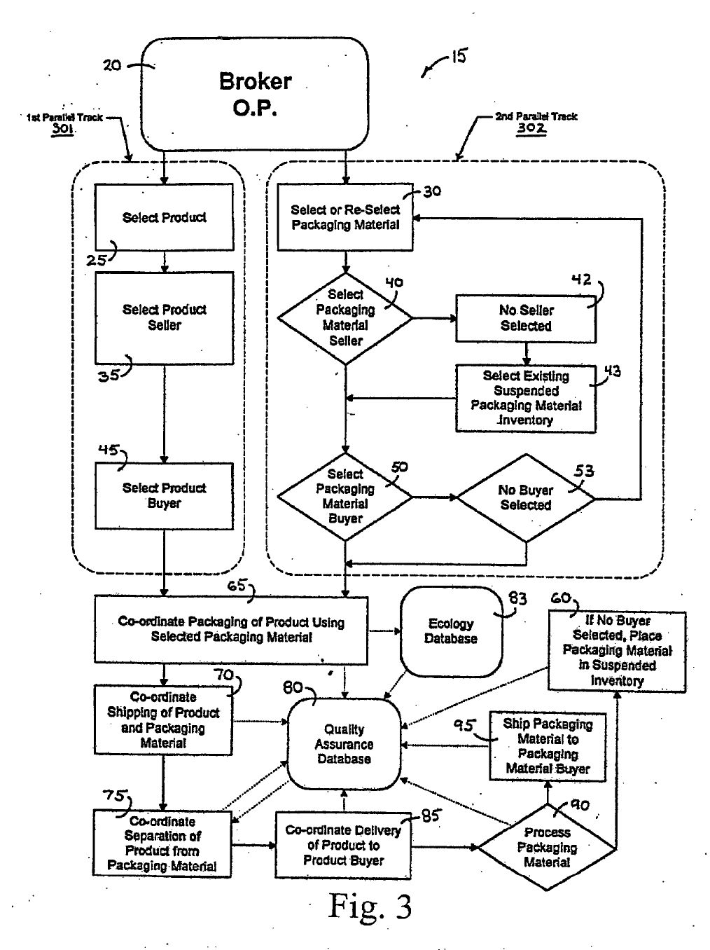

The packaging system of the present invention also includes a computer based optimization program that automatically coordinates the distribution of the first product as optimally coupled with a second product packaging element. The logical processes of the distribution optimizing program are shown in FIG. 3. A general example of the packaging system 15 is implemented by the Optimization Program 20. The Optimization Program begins with the selection of a product 25 and a material for packaging the product 30. Preferably, as discussed above, the product is a perishable food item, typically a fruit or vegetable. The perishable produce product is actually the first product and the packaging material the second product, because, like the first product, the packaging material is also purchased by a buyer as a commodity. The computer based Optimization Program achieves the most expedient and best matching of packaging material to product and their transportation to appropriate buyers.

A user of the packaging system 15 is referred to herein as a broker. The broker operates the Optimization Program 20, initiating and monitoring its processes while providing the required inputs or access to needed data. The broker initiates the Optimization Program by requesting a product and packaging material pairing. The product 25, and a buyer 35 and a seller 45 for the product, are selected by the program. A packaging material is also selected that includes a source for the packaging material 40 either from a seller or from a suspended packaging material inventory 43. The suspended packaging material inventory is an accounting of unsold packaging material from previous product transactions that is stored and inventoried by the Optimization Program for filling its future product packaging needs.

The Optimization Program 20 preferentially also selects a buyer 50 for the packaging material. If no buyers are available 53, the Optimization Program re-selects an alternative packaging 30 on the chance that both a buyer and a seller can be found. If no packaging material buyer is selected, the Optimization Program will eventually place the packaging material into suspended inventory as a final step 60.

After the product is selected 25 and the packaging material is selected 30, and their individual sellers 35 and 40 and buyers 45 and 50 established, the Optimization Program 20 oversees and coordinates the processing required to deliver the product and packaging to the selected buyers or destinations. First the product must be packed and prepared for transport 65. The proper configuration required for the selected transport must be verified and the timely supply of the packaging material to the product seller for packing ensured. These checks and verifications are either output to the broker or directly to the entity responsible for that specific matter. For instance, the quantity and configuration of the packaging material required for a particular shipment could be automatically transmitted by facsimile or internet from the broker computer directly to the packaging material seller, without specific review by the broker.

After the packaging of the product, the combined product and packaging can be transported 70. The Optimization Program 20 selects the best route and mode of transportation and tracks progress along that selected route to verify the combined product and packaging reaches its destination on time and in the best possible condition.

The product and packaging material are separated 75 before delivery to their respective buyers. A component of the packaging system of the present invention is the monitoring and controls included in a Quality Assurance Database 80. The optimization system 20 employs the Quality Assurance Database to evaluate the condition of the first product and the second product at the separation of the first and second products. This evaluation is a quality assurance control mechanism that ensures that the products are in the best possible condition so that quality assurance is optimized during transit or handling and a minimum of degradation occurred in transit or handling. This quality assurance control mechanism can communicate with the Optimization Program continuously and in real time. Information is rendered to the Quality Assurance Database for identifying the status of the combined products to formulate a starting quality benchmark of the combined products.

The delivery of the product to the product buyer is also coordinated 85 by the Optimization Program 20. The delivery must be performed on time and to the needed location. The packaging material also sent to the packaging material buyer 95 or to a suspended inventory location 60 as discussed above. The packaging material will typically require some additional processing 90 to be in a form needed by the packaging material buyer. The Optimization Program can also facilitate this processing.

Alternatively, the packaging material will remain with the product until the product buyer separates them. The retrieval of the packaging material is then coordinated by the Optimization Program 20 and the packaging material transported to the packaging material buyer or to a suspended inventory location.

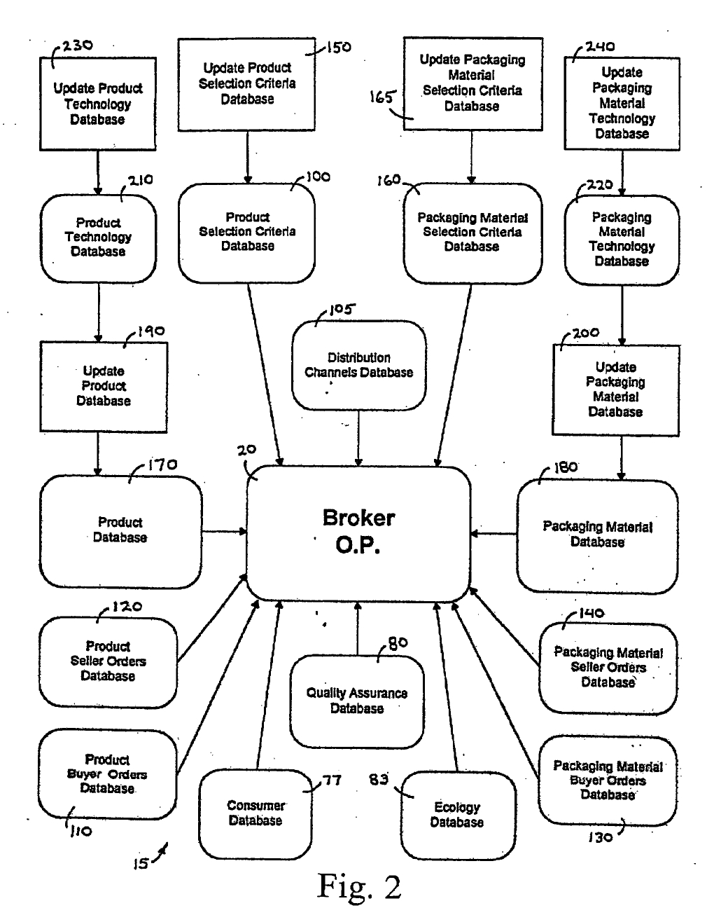

Each logical operation of the packaging system 15 will now be described in greater detail as schematically shown in FIGS. 2 and 3. FIG. 2 shows inputs to the Optimization Program 20, also referred to as a Broker Optimization Program (Broker O.P.). The computer (not shown) that includes the Broker O.P. preferably includes a central processing unit or C.P.U. but also preferably includes the components present in a conventional personal computer: A memory storage such as a hard drive, a ROM memory containing the system BIOS, a RAM memory, an operating system, a monitor, a keyboard and a mouse or similar pointer device.

FIG. 2 schematically illustrates the inputs to the Broker O.P. 20 and begins with 20 the Product Selection Criteria Database 100. The Product Selection Criteria Database is preferably stored in the hard drive of the Broker O.P. computer. The Product Selection Criteria Database supplies the Broker O.P. with the data required to determine which first product is selected for shipping with a particular packaging material to a specific destination. The Product Selection Criteria Database preferably includes all pertinent “non-sales” facts. Non-sales facts are defined as information pertinent to the specific product, other than buyer orders and seller orders, needed to ensure the product can arrive at a selected destination at a desired time and in the desired quantity and desired quality. This non-sales information may include specific transport requirements for the particular first products, and limitations regarding temperature and other appropriate ambient conditions, storage periods, and market dates.

Travel timing constraints impact all perishable commodities at some point. The availability of transport, the connection of one transport mode to another, and the closing of ports due to civil unrest, strike and natural disaster, are all vital in calculating the optimum route and estimating the travel time. It is vital that each product reaches the desired destination before spoilage and in time for the desired sales purpose, whether for retailer or wholesaler stock, a processing plant schedule or other critical need. Timing constraints will limit the reach or shipping distance of some perishable first products. A Distribution Channels Database 105 can provide the Broker Optimization Program 20 with updated and vital information regarding an entire distribution chain, which includes transportation and distribution channels. Once initial schedules and requirements for an individual transportation mode are input, the update task will primarily include revising the existing database information, likely stored in the spreadsheet matrix.

The quality of the product is directly affected by the distribution and shipping choices. An accurately controlled Distribution Channels Database 105 assures improved quality for both the packaging material and the product

Additionally, as also schematically shown in FIG. 2, pertinent facts relating to sales and purchase information are collected in the respective Product Buyer Order Data Base 110, Consumer Data Base 77, Product Seller Orders Data Base 120, Packaging Material Buyer Order Data Base 130 and Packaging Material Seller Orders Data Base 140. The quantities available for sale are updated into the Product Seller Orders Database and the Packaging Material Seller Orders Database.

The Product Selection Criteria Database 100 should also be updated. The Update Product Selection Criteria Database 150 includes an input to Product Selection Criteria Database of all facts relating to monitored storage criteria, such as; temperature ranges, humidity, and gas composition information for gases such as oxygen, nitrogen, ethylene, along with total gas leakage rates and generation rates. The Product Selection Criteria Database communicates with the Quality Assurance 80 database through the Optimization Program 20 to provide a final picture of a quality differential of the products. The quality differential of the products is herein defined as the benchmark quality versus the final quality. The input to the Product Selection Criteria Database could be performed by entering data with the aid of the keyboard in a spreadsheet format. Once initial schedules and requirements for an individual transportation mode are input, the update task will primarily include revising the existing database information, likely stored in the spreadsheet matrix.

The packaging material is a second product in the present invention. The packaging material is selected and integrated into the first product by the operating system 20. The packaging material may be purchased and sold as facilitated by the packaging system 15 of the present invention in much the same manner as the first product. However, the packaging material typically will have the advantage of being non-perishable. This relieves an additional layer of logical operations that optimize the travel conditions and timing requirements for the second product which comprises the packaging material. Additionally, the second product packaging material typically has a lower margin of profit than the first product and as such can be given a lower priority in the Optimization Program. However, the inventor recognizes that in some instances the packaging material could be of greater value than the first product, and as such demand a higher priority in the directing of the second product to the buyer of the packaging material.

The logical processes of the distribution optimizing program 20 are shown in FIG. 3. The Broker Optimizing Program employs the inputs as illustrated in FIG. 2 to prioritize and route the distribution of the first product packaged within the second product.

The optimization of the packaging system 15 includes two parallel tracks of logical tasks. The first product parallel track 301, comprises Select Product 25, Select Product Seller 35 and Select Product Buyer 45. The selection of a product is made by a first product selection query into the Product Selection Criteria Database 100, the Product Buyer Orders Database 110 and the Product Seller Orders Database 120.

If there is a found set of product sellers and product buyers that meets the specific criteria required for a specific product combined transaction, the transaction is 30 executed by the Optimization Program 20. The specific product combined transaction is defined as the brokering of the first product received within the second product packing material.

Preferably, the broker does not actually purchase the first product nor the second product. The broker only facilitates the transaction, insuring the satisfaction of the buyer as receiving the specific product as requested in the best possible condition for sale or incorporation into a process. The combined transaction is executed by the broker's computer (not shown) at the direction of the Broker Optimization Program 20.

Additionally, the broker can be described as an underwriter for the transaction for the first product as combined with the second product. The broker can enter a “performance contract” with the provider of the first product and the second product. The broker can ensure that the quality of the first product and the second product remains high during packaging, transport, and distribution, while the seller of the product and seller of the packaging material guarantee the availability and quality of their respective commodities.

The second parallel track 302 of the packaging system logical operations includes Select or Re-select Packaging Material 30, Select Packaging Material Seller 40 and Select Packaging Material Buyer 50. The selection of a packaging material for use as the second product is made by a second product selection query into the Packaging Material Selection Criteria Database 160, the Packaging Material Buyer Orders Database 130 and the Product Seller Orders Database 140.

Similar to the Product Selection Criteria Database 100 the Packaging Material Selection Criteria Database 160 should also be regularly updated. The Update Packaging Material Selection Criteria Database 165 includes an input to Packaging Material Selection Criteria Database of all facts relating to storage and structural limitations, including temperature and humidity ranges and loading characteristics. The input to the Packaging Material Selection Criteria Database can be performed by entering data with the aid of the keyboard in a spreadsheet format.

Next, the Optimization Program 20 queries the Packaging Material Seller Orders Database 120 for packaging material sellers. If the packaging material seller selection query returns the “null set” for potential packaging material sellers, the optimization continues with No Seller Selected 42, the seller selection is bypassed and the Optimization Program proceeds to Select Existing Suspended Material Inventory 43. The packaging material is provided for the specific first product selected in the first parallel track by removing the second product packaging material from the inventory suspended or unsold from previous shipments of combined packaging, in which buyers for the packaging material were not selected by the Optimization Program 20. This suspended inventory remains within the system and is stored at locations proximate its eventual likely use, for later incorporation back into the system as a packaging material or directly as a second product.

Next, selection of the Packaging Material Buyer 50 is performed. The Optimization Program 20 queries the Packaging Material Buyer Database 140 for packaging material buyers. If the query returns the null set for packaging material buyers, the Optimization Program continues with No Buyer Selected 53. When no buyer of the second product packaging material is selected the Optimization Program reiterates with a secondary choice of packaging material, if available. If the result for buyers of the packaging material for all available packaging materials, as found in the Packaging Material Selection Criteria Database 160, remains the null set then the optimal packaging material is re-selected and the packaging material is designated for addition to the suspended inventory. With the use of the suspended inventory, a specific ultimate destination of the packaging material second product can be undefined. The suspended inventory acts as a buffer or bank for assuring the smooth supply of packaging material for perishable first products.

The first parallel track 301 and the second parallel track 302 of logical process operations by the Optimization Program 20 result in specific sellers and buyers of specific quantities of first products and second products. The Optimization Program now must direct the broker computer to Co-ordinate Packaging of Product Using Selected Packaging Material 65. This operative step is critical for the execution of the combined transaction by the broker computer. The coordination of packaging the product comprises the output of the specific first product's specifications to the seller of the packaging material. The product specifications include the quantity of the packing material required and the size and configuration of the required packing material. The time and place of the packaging material's delivery to the site of the product critical for timely packaging of the first product, are also provided. This information is particularly important when the first product is perishable and needs to be packaged and shipped immediately to prevent spoilage or obtain a maximum shelf or storage life. These product specifications are obtained by a product specification query by the Optimization Program into the Product Database 170 and the Product Selection Criteria Database 100.

Similarly, the specifications of the packaging material are also important in the coordination of the packaging. The packaging material specifications are found by an appropriate query by the optimization program 20 into the Packaging Material Database 180 and the Packaging Material Selection Criteria Database 160. Unique value adding packaging materials' specifications or compositions can be configured that combine the specific requirements of the buyer, through interactive databases between the supplier, the broker, and the buyer(s).

After the first product is efficiently packaged with the second product, the combined products are shipped to the first product's destination. The coordination of the shipping of product and packaging material is conducted by the broker computer at the instruction of the Broker Optimization Program 20. The Broker Optimization Program queries the Product Seller Orders Database for specific destinations where the first product is required. The Broker O.P. then queries the Product Selection Criteria Database 100 for constraints regarding the selection of a shipping mode for the first product. With the constraints or limitations of shipping for the specific first product, the Broker O.P. can Coordinate Shipping of Product and Packaging Material 70, selecting the most cost-effective route that will transport the first product to the required destination of the buyer at the requested time, according to quality assurance parameters.

The operation of Coordinating Delivery of Product and Packaging Material to Buyer 70 typically consists of various Update to the Product Database 190 and the Update to the Packaging Material Database 200 regarding the progress and location of the combined shipment. The updates allow the Broker O.P. 20 to monitor the combined shipment and report any irregularities of the shipping process. Irregularities can include delays or damage to the combined product. Preferably, each shipment is telemetered to the broker computer by way of global positioning and satellite communications. The status of the shipment, including temperature and all ambient conditions, and location, is especially important for perishable products that require the maintenance of conditions in a specific range to prevent the product from spoiling. Based upon the information retrieved from the individual shipments in transport, the Optimization Program could also remotely adjust the conditions of the shipment to conform within the specific range of desired conditions, such as temperature and other ambient criteria.

By providing monitoring, tracking, feedback and controls the broker obtains the advantage of accessing and possibly controlling an “open distribution system.” Through this access, the product can be individually scrutinized at each possible change of hands, where potential damage can occur to the product. The packaging system of the present invention approaches a “closed distribution system,” but improves upon a closed system to transform it into a “transparent” closed system. This transparency results in a packaging system with more control than a closed system but with less damage compared to an open system. The individual product items are not manually inspected or scrutinized but automatically monitored, providing the quality assurance of the open system without the expense or inherent damage to the product that occurs in handling operations. The Quality Assurance Database 80 provides this feedback to the Broker O.P. 20. The Quality Assurance Database receives information at the packaging 65 shipping 70 and separation 75 operations to provide the Broker O.P. with information on the quality of the first and second product.

Additional information relating to the acceptability and end condition of the first product and the second product relating to the consumer can also be gathered and used by the Optimization Program 20. The preferences and tastes of the consumer are reflected in the purchase patterns of the specific first and second products. Sales information may be available for individual product sales, product portions, segments or groups. This information can be collected in the Consumer Database 77 schematically shown in FIG. 2, for use in fine tuning elements of the optimization system such as packaging alternatives, transport conditions, and presentation of the packaged produce.

The Update Product Database 190 and the Update Packaging Material Database 200 both require input relating to product technology and packaging material technology, respectively. A Product Technology Database 210 and a Packaging Material Technology Database 220 can each provide developments in new products, packaging materials and related technologies to keep the Broker O.P. 20 abreast of these breaking technologies. Universities, marketing boards, industry forums and publications can all provide such technical information. Updating Product Technology Database 230 and Updating Packaging Material Technology Database 240 are both important to keep the respective technologies current and competitive.

The combined product and packaging material of the present invention can result in an ecologically desirable reduction in waste when compared to conventional product packaging systems. The ecological benefit of waste reduction and efficient distribution is an additional factor that can be employed in decisions made by the Optimization Program 20 to ensure the ecological benefits of the packaging system 15. As shown in FIG. 2, an Ecology Database 83 provides data to the Optimization Program so that it can weight decisions and selections away from ecologically inferior packaging materials or distribution channels and encourage the selection of ecologically superior packaging materials and distribution channels.

As shown in FIG. 3, the Ecology Database 83 can receive information relating to the selected product and packaging from the Coordination of Packaging of Product Using Selected Packaging Material 65. The Ecology Database can then supply ecologically related information to the Quality Assurance Database 80, to emphasize environmental quality as a key element in overall product quality assurance.

The benefits of ecologically minded decisions often results in cost savings and is a vital marketing tool. The acceptability and saleability of the first product and the second product are enhanced by “ecology smart” decisions affecting almost every aspect of the packaging system 15. Many markets are eager to receive ecology smart products and will preferentially select such products. In many markets, products with wasteful packaging are banned or at least penalized with tariffs or added fees. The incorporation of ecology into the packaging system ensures that potential marketing and waste reduction advantages are realized and unsound ecological decisions by the Optimization Program 20 are avoided.

Once the combined package including the first product and the second product is received by the buyer of the first product, the second product must be retrieved or shipped to its destination as determined in the second parallel track 302 of logical operations. The retrieval of the packaging material is typically an instruction to the buyer of the first product as to when the packaging material will be retrieved for further processing or pickup for shipping to the packaging material buyer. If no buyer was available or selected by the Optimization Program 20, the packaging material is placed into suspended inventory 60. The packaging is shipped to a specific location where it will remain until needed again, whether to sell to a second product buyer or for use as packaging for another first product. The buyer of the packaging material will not likely use the packaging material in its packaging element form, but will convert or process the packaging material 90 into a manufactured item or material. The packaging material is in this regard a convertible commodity. A commodity as herein defined is any material that has a value and can be traded on the world market. The commodity is convertible because it can first serve as a packaging element, then serve in and additional role or purpose, such as a raw product input to a manufacturing process.

Alternatively, this Optimization System 15 could be employed when the packaging material remains with the first product as a display and storage aid. The second product could also be an edible or desirable commodity. This would simplify the selection and distribution process as described herein, but the framework of the Broker O.P. 20 would still be helpful in facilitating the packaging, distribution, tracking and feedback that the present invention provides.

The following scenario illustrates a specific embodiment of the present invention. A wood pulp seller or buyer can place a sell order with the Broker Optimization Program 20 computer either by directing the broker to enter the sales request into the system, or entering the sell order directly through a telephone or internet connection. Similarly, an apple seller or buyer can place an order with the broker or directly enter the request into the broker computer. The Broker O.P. computer is preferably a network of computers and databases that are connected over a wide area network such as the internet. Individual nodes of the packaging system's Broker O.P. 20 track and compile information specific to the optimization of the specific first products and second products that are bought and sold through that particular site.

In this preferred embodiment of the present invention, additional information is also input into the Product Buyer Order Database 110 along with the buyer order. The date of availability of the apple first product or pulp second product, the quantity available and specifics such as expected grade of the apple, all aid the Optimization Program's selections.

Much of the information contained in the Product Selection Criteria Database 100 is queried by the Broker O.P. 20 for other databases within the packaging system 15. The primary task of the Broker O.P. is to match product sellers with product buyers, in cooperation with packaging material sellers matched up with packaging material buyers. The Product Seller Orders Database 120 collects information regarding the suppliers of the first product. The information collected may include: The quantity of apples expected in the harvest, the variety of the apple, the preliminary grade or quality and size of the apple, the exact date of harvest, and the location of the orchard.

The costs of this packaging system can essentially be suspended to the producers of the first product. This system would further allow the producer to receive direct payment for the shipment or even individual pieces of fruit at the time an individual portion is sold; e.g. at a retail market. The payment for the shipment could easily be accomplished through electronic banking and database networking. The tracking and management of each product portion or parcel also allows this suspension of reduced costs and risks to be passed on from the producer to an end user directly, in accordance with any appropriate producer performance parameter.

Similarly, the Packaging Material Seller Orders Database 140 is queried by the Broker O.P. to match packaging material sellers with packaging material buyers, in cooperation with first product sellers matched up with first product buyers. The Packaging Material Seller Orders Database collects information regarding the quantity of pulp available and directs the conversion of the pulp into shelves of sizes expected based upon the sizing and quantity information queried from the Product Seller Orders Database 120.

A database engine employing a user customized interface, such as Informix™ or Oracle™ are preferred choices for configuring the various required databases and queries as required for the present invention. With the known Source Query Language (SQL) capabilities of these databases, the programming required to optimize and coordinate the system to these required specifications is readily achievable by a programmer skilled in the art.

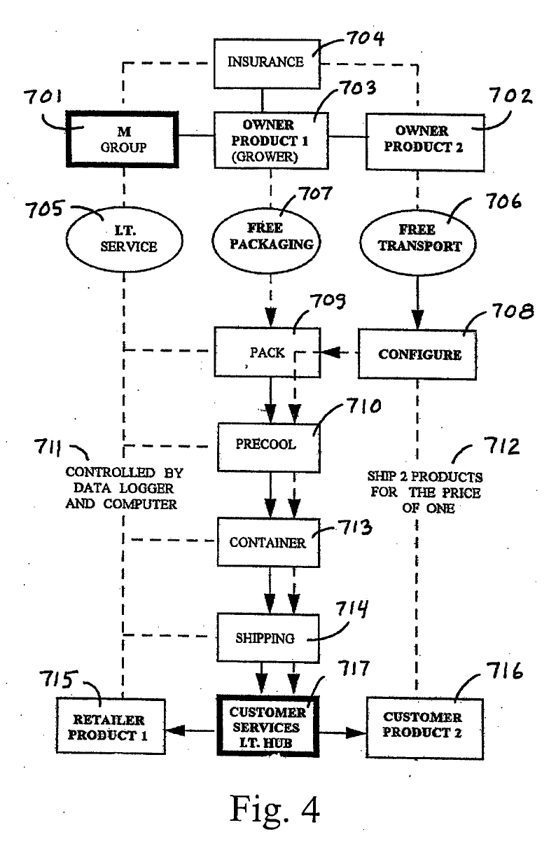

The invention is further illustrated by FIG. 4. FIG. 4 presents the invention with regard to using secondary fibrous products with primary products, such as fruit. The secondary product is used to actually package the primary product in a packaging facility. This method incorporates a closed loop system, which provides no interference to the products from the time of packing to the time the primary product is delivered to the retailer. This method is valid for container shipping as well as break bulk methods of shipment.

Ideally, the primary product is quality controlled and shipped in containers which should have Controlled Atmosphere, in addition to temperature and humidity control, to primary product's target market retailers. All conditions of the container, including identification, GSM positioning, and ambient conditions are monitored and managed 711, to maintain optimum conditions, and are traceable as to location en route. They may be continuously monitored through Customer Information Centers as regional distribution hubs 717.

After the separation process, the secondary product can then be reconfigured, according to local market laws or practices, for the local market as a primary product, or for re-export and distribution to another country. It can be directly sold for use as newsprint/printing material on the local market itself, or as in the case of feed stock, such as tapioca or other grains or modified starches, reconfigured, cleaned and sold in the local market itself.

This approach when employed in product distribution mechanisms can also result in fuller utilization of valuable container storage. This is what is called the “stovepipe” mechanism. Using modern logistics and tracking systems, in conjunction with an optimization model, in effect, this provides the mobile storage capability for other (primary and/or secondary) products in transit to export markets.

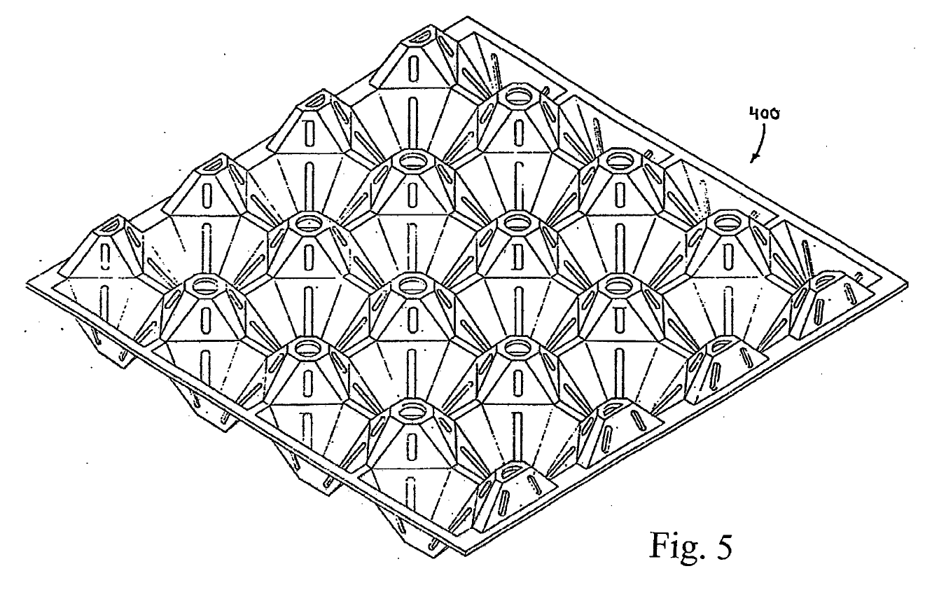

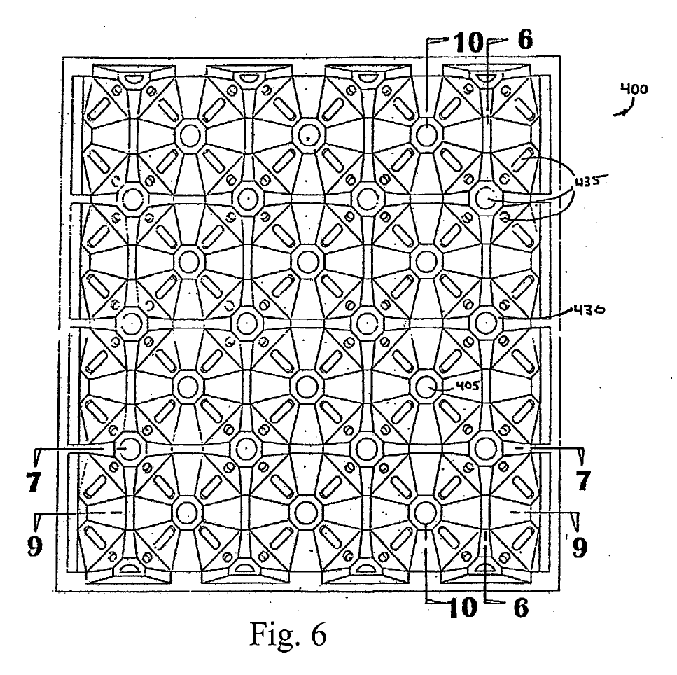

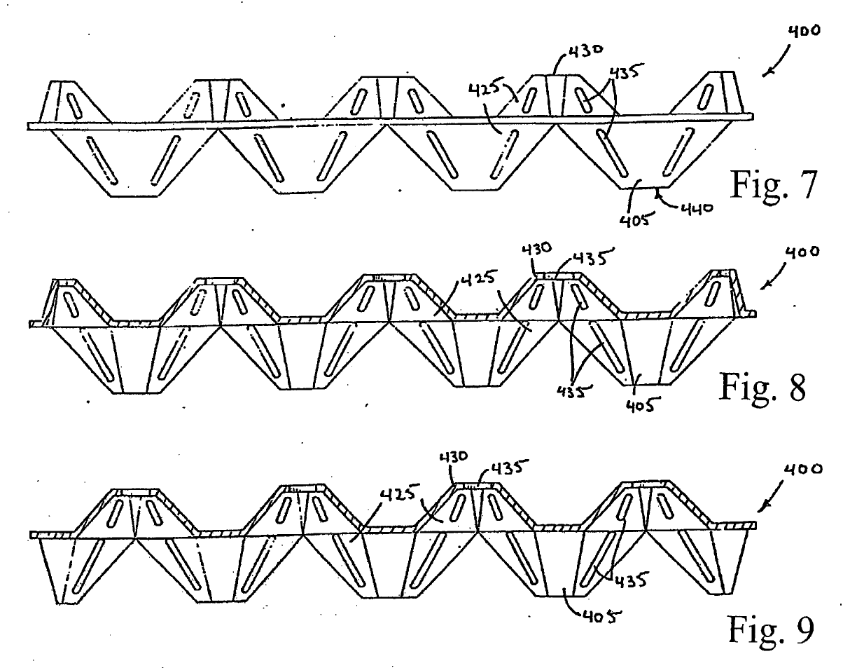

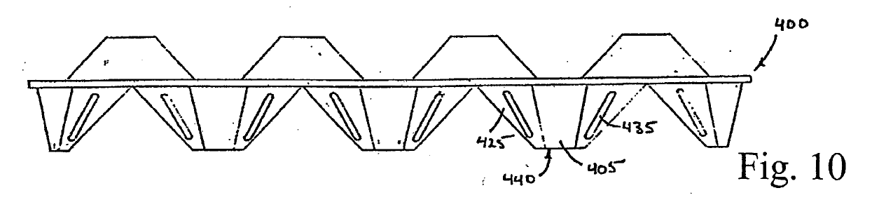

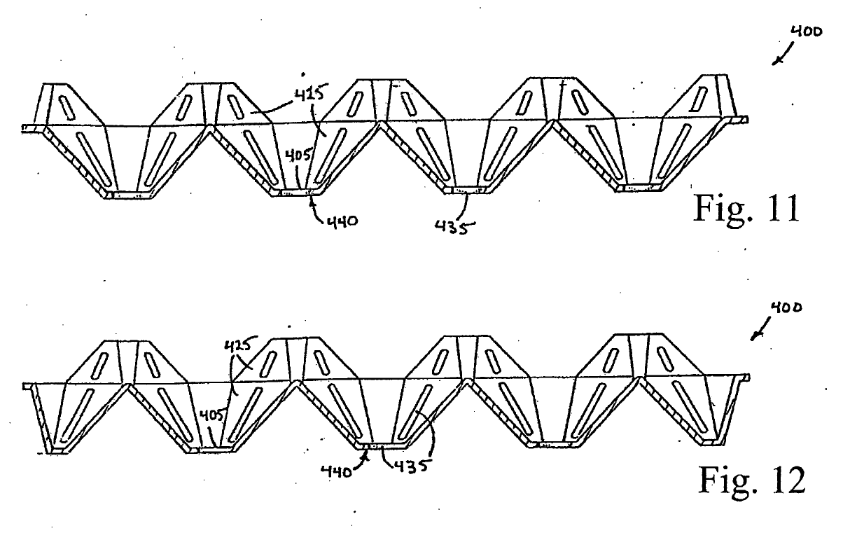

Preferably the first product is relatively small, requiring significant packaging material to individually encase and separate each first product item. Also, the first product is preferably mass produced and is shipped in large quantities, to encourage the cost savings of larger scale packaging material co-shipments. More preferably, the first product is any fruit or vegetable that is suitable for transport. An apple first product is shown in the apple shelving embodiments of the packaging element in FIGS. 5 through 16.

In a preferred embodiment of the present invention, the first product can be apples and the second product can be paper pulp. Paper pulp is produced in temperate geographic regions with conifers grown in large quantities for producing wood fiber. These temperate forests are often proximate apple producing regions. This proximity of paper pulp sources to tree fruit products that can use pulp paper for packaging material in the form of shelves manufactured from the pulp is already exploited. The practice of employing paper pulp in apple trays is widespread and an industry standard.

However, at a consumer level, after the end use of the apple or any other appropriate first product, the packaging material is discarded, resulting in the loss of the potentially enormous value-adding possibilities of packaging material. Comparable to the preferred apple packing shelving embodiment of the present invention apple trays are currently employed in the industry. The apple trays are typically dyed, which aids in their designation a non-reusable or convertible commodity. The practice of recycling cardboard materials is employed in industrialized areas; however the costs outweigh the savings of recycling, except for public relations purposes. In undeveloped consumer markets packaging materials are burned for quick disposal or for heat, or are simply discarded. Another advantage of the present invention is realized in areas that restrict the influx of packaging materials that fail to account for their ultimate fate as a waste material. The use of the packaging material as a second product allows the packaging to be transported into these areas without restriction or tariff.

The value of a formed wood pulp, or any specific customer composition apple shelving is realized at the consumer level when a conscious effort is made to ship the pulp shelves as a convertible commodity for consumer use, as provided in the present invention. The apple is destined for a store or market and the pulp shelves can easily be converted to another form if the paper pulp shelving is transported in bulk to a location, preferably near the destination of the apples, where the pulp can be processed into a marketable product. The paper pulp shelving serves a purpose with the apple shipment and yet is essentially a second product co-shipped with the apple. This second product in the preferred embodiment of the paper pulp apple shelving has a definite market, especially in area where tree harvesting for fiber production does not occur and inexpensive virgin wood fiber is not available. Such a situation exists in many industrial centers throughout the world. The apple shelves must be a uniquely designed packaging element that facilitates the packaging system to provide a shelving that is adaptable to a wide range of transportation modes and packaging configurations.

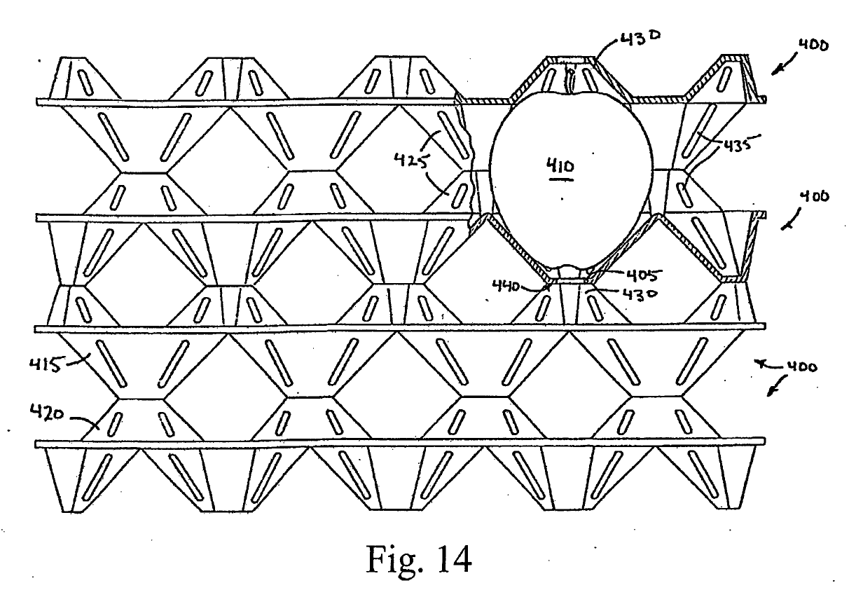

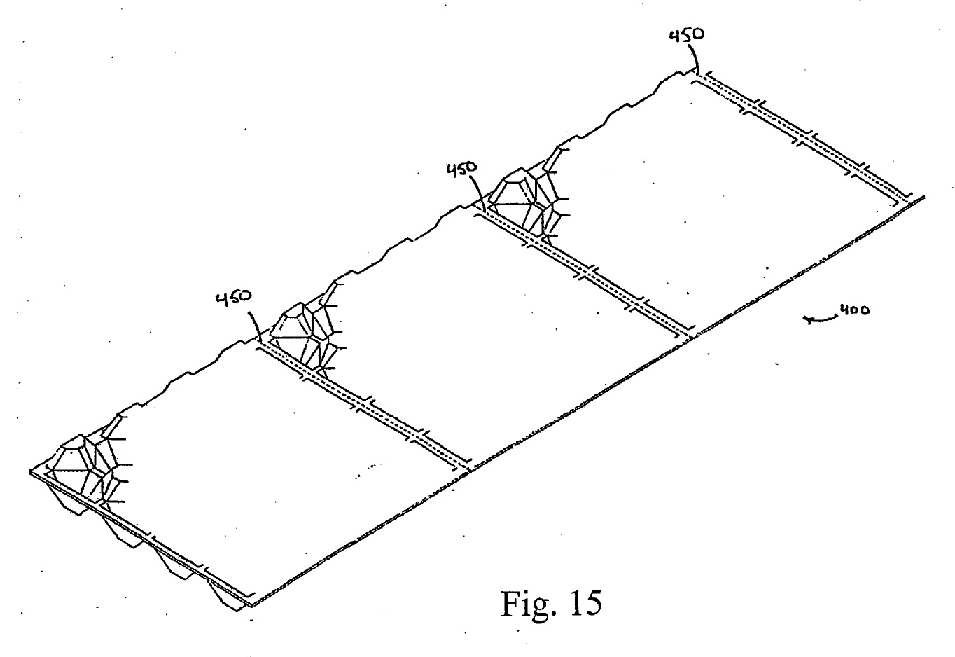

The first product is apples in this, a preferred embodiment of the invention as shown in FIGS. 5 through 16. The shelves 400 for apples include a plurality of indentations 405 for receiving the apples. The indentations proximately conform to the exterior shape of an apple 410. FIG. 14 illustrates a shelving that is uniquely tailored for a specific apple varieties with tapered instead of rounded fruit. Preferably however, the size and shape of the indentations have a tolerance for a variety of varied apples, or other fruits or vegetables. Though the rounded indentation configuration reduces the maximum achievable density of apples packed into the shelves, the tolerance allowed by the more rounded indentations enable the shelves to be used for many alternate fruit or vegetable varieties. The design of the shelving is preferably as standardized as practicable, enabling the widest range of sizes and shapes of the first product for a particular shelving.

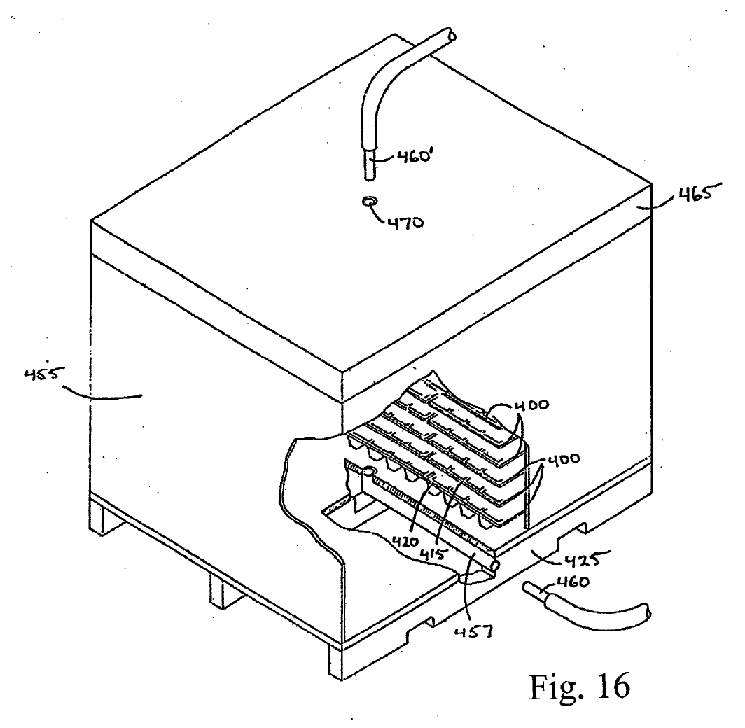

The design of the shelving 400 also provides for the support of the produce contained therein, by the individual shelves. None of the shelves rest upon the produce for support. A second shelf 415 stacked upon a first shelf 420, as shown in FIG. 14, are supported by the first shelf below them. Damage to the produce is minimized and the weight of each shelf with the produce on it is transferred to shelves below it, down to the pallet 425 that supports the entire stack of shelves, as shown in FIG. 16.

Because the packaging material is a second product, the conventional focus of minimizing the packaging material for a given application is replaced with a new packaging strategy made possible by the present invention. This new packaging strategy entails maximizing the packaging material within a given volume and maximizing product density within a volume of transported and packaged product. The spaces and air pockets present in packed produce are minimized in this new strategy and the structural support of the produce is increased instead of compromised.

Preferably, the 405 have a regularly repeating pattern that arranges the apples in the most efficient pattern that maximizes the density of the apple pack and still prevents them from contacting and bruising each other. The shelving 400 for apples also preferably includes an interconnecting sidewall 425 and an intersectional dome 430. The interconnecting sidewall separates each adjacent indentation 405 in the apple shelves. This is a marked improvement over conventional apple trays that stack apple trays upon apples, creating quality problems at the consumer level.

Preferably the interconnecting sidewalls 425 also include penetrations 435. The penetrations can be slots, perforations, holes or openings that increase air flow though the individual shelves 400. This feature is very important when the apple must be quickly cooled to retain freshness or when respiration reducing environments are employed to preserve the apples for extended periods. Not every sidewall needs to contain penetrations. Sometimes, to minimize the movement of air through the shelves or maximize structural strength of the shelves, no penetration may be wanted. Other situations are considered where small numbers of penetrations are wanted to provide a limited movement of air between the shelves. Penetrations can also be included between the domes 430 and a base 440 of the indentations in stacked shelves, as partially shown in FIGS. 8, 9, 11 and 12, and entirely shown in FIG. 14.

The penetrations 435 can align to allow the passage of air between the shelves 400. The penetrations can also be engineered to direct air flow through the stacks of shelving in a desired pattern (not shown). An example could be to increase in penetrations in the interior of the shelving to encourage ventilation through the center of the shelves.

The shelves 400 stack efficiently upon one another and supports the weight of the apples 410 packaged within. In a specific embodiment of the first shelving as shown in FIG. 14, the base 440 of each indentation 405 of the second shelving 415 can support the intersectional domes 430 of the first shelving 420. The second shelving and each additional shelving stacked thereon is preferably substantially identical in form to the first shelving. The shelves can be mass produced, formed from pulp paper by The well-known vacuum suction molding process. This process can be enatic in the exact dimensions of the shelving. The shelves will be reasonably identical, but the nature of the process must allow for some slight variability in the product.

To aid in the stacking of the shelves 400, coupling recesses (not shown) and coupling mounts (not shown) can be included in the shelves. The base 440 of an occasional indentation 405 or all of the indentations on a second shelving 415 or stacked shelves can include a coupling recess for receiving a similarly shaped coupling mount Again, the second shelving stacks onto the first shelving 420. A coupling mount of a similar shape to the coupling recess can extends from the dome 430 of the first shelving, toward the second shelving and insert into the coupling recess. This coupling of the first shelving and the second shelving helps to prevent the individual shelves to slip sideways. Sideways slips of the shelves may result in damage to any crushable contents of the shelves. Interlocking the shelves with the coupling recesses and coupling mounts reduces his unwanted side slip.

Conversely, an occasional dome 430 or all of the domes on the first shelving 420 can include a coupling recess (not shown) for receiving a similarly shaped coupling mount (not shown). A coupling mount of a similar shape to the coupling recess can extends from the base 440 of the indentation 405 of the second first shelving, corresponding to the coupling recesses in the domes. The coupling mounts can extend toward the second shelving and insert into the coupling recess.

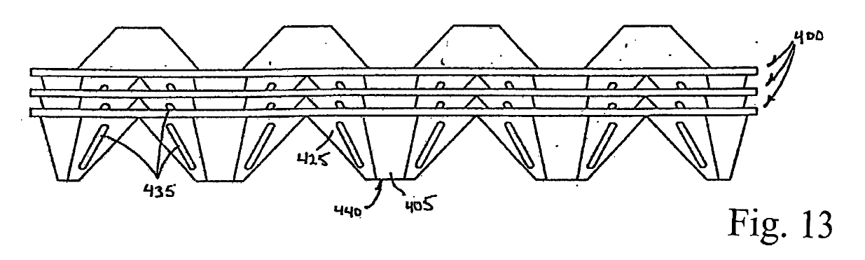

As shown in FIG. 13, the shelves 400 should also be able to nest. The second shelving 415 nests upon the first shelving 420 when the second shelving is rotated 90° (ninety degrees) relative to the first shelving in a plane parallel to the first shelving. When the indentations 405 of the shelves are empty and free of fruit such as apples 410, the base of each indentation of the second shelving can nest into each indentation of the first shelving. The result is a nested stack of shelves that occupy much less volume than the shelves occupied when stacked and containing apples.

Additionally, the shelves 400 can be fabricated out of almost any formable material. The inventor considers a variety of materials as candidates for packaging materials. Pressed corn meal, rice meal, tapioca, newsprint, salt, and sugar, all have potential for use as packaging materials that could form packaging elements for a specific first product.

The shelves 400 can also include tear perforations 450 as shown in FIG. 15. The perforations allow the shelves to be formed in a continuous length. The tear perforations provide flexibility in the entire packaging process. Continuous shelves can conform to the length of the shipping container or truck that transports the shelves and product received thereon. Additionally, when the truck or shipping container is unpacked, the shelves can again be separated at perforations for smaller, display sized configurations, e.g., stacked and strapped shelves to simulate the shape and size of a traditional carton. The continuous shelving lends itself to conveyor style packing and unpacking. The shelving is packed in a steady stream of product placed onto the shelves. Similarly, when the shelving is unpacked, rather than individual trays or boxes, continuous lengths of shelves, the full length and width of the shipping container, trailer or truck, provide a steady stream of product to a processor using a conveyor belt system to separate the shelving from the product it contains.

As previously mentioned, the shelves 400 can include penetrations 435 to increase the circulation of air through the stacked shelves. It also facilitates faster “pull-down” or reduction in temperature, which can also provide substantial energy savings. Pre-cooling produce immediately after harvest, before the placement of produce into cold storage, reduces the cost of cold storage cooling and more quickly arrests the ripening process. The flow of air through the stacked shelves is not only important in the quick pull down in pre-cooling produce contained in the shelving, but the flow of air is vital in establishing and maintaining respiration reducing environments. These respiration reducing environments or controlled atmosphere applications remove oxygen from the air surrounding the perishable products. The low oxygen levels slow the ripening and spoiling of the perishable product, extending its shipping range and shelf life.

FIG. 16 shows an alternative embodiment of the present invention that includes the shelves 400 in a controlled atmosphere application. The shelving is stacked within an air tight enclosure 455 and conditioned air is pumped through the enclosure. The air can be conditioned for temperature, humidity, gas composition or only to provide forced ventilation.

Ethylene is a naturally produced ripening agent. Ethylene is released by many perishable fruits and vegetables. The removal of ethylene released by the produce, slows the ripening process and extends the travel range and shelf life of the produce, such as apples 410.

The enclosure 455 can be insulated to slow the flow of heat into or out of the packaged produce. The pallet 425 supporting the shelves 400 can be of a conventional design, modified with an air pipe 457 as shown in FIG. 16. The air pipe is fitted with a hose 460 to supply or return gases to or from the enclosure. A one-way configuration (not shown), without a return hose, is also possible within a second enclosure such as a ship's container or cold storage. More preferably, the pallet is formed from the same material employed in the shelves. A pallet formed of the packaging material second product would not need to be formed for light weight and of a minimum of material. The pallet could be essentially a solid block of second material and for the controlled atmosphere application include air flow channels (not shown) or most preferably a plenum (not shown) with a perforated surface to distribute or collect the air to or from the enclosure.

For the top of the enclosure 455 a cap 465 is provided that includes an air pipe connection 470 for receiving a hose 460′. As with the pallet 425, the cap 465 can also be fabricated from the second product. The cap can include air flow channels (not shown) or most preferably a plenum (not shown) with a perforated surface to distribute or collect the air to or from the enclosure.

The air pipe 457 and air pipe connection 470 of the enclosure 455 as described above, can be connected to a controlled atmosphere (C.A.) generator (not shown) with the hoses 460 and 460′. Multiple enclosures could be connected to a larger controlled atmosphere generator or a smaller controlled atmosphere generator could service a single enclosure. The controlled atmosphere generators could be portable and able to run by internal battery power, externally supplied electrical power, or electricity supplied by a small onboard generator. The atmosphere generator need not include the ability to refrigerate the air supplied to the enclosure. The enclosure can continue to be stored within conventional refrigerated storage.

The quality control that a small enclosure 455 affords is superior to a large C.A. storage room is significant. Additionally, the enclosure as described above, provides mobile distribution of small C.A. quantities vastly improving the condition of produce supplied to the consumer and giving an assurance of quality that is unavailable with conventional systems.

An initial test of the disclosed fruit handling system invention was conducted by Dr. Max E. Patterson, Professor & Horticulture Scientist Emeritus at Washington State University. The test of the disclosed system demonstrates the potential significant benefits for the apple industry, trucking companies, retailers, the consumer and the environment. The test was designed to determine if the new system would protect fruit from physical damage if the boxes were removed, or would absence of boxes increase damage above normal levels? A test pallet loaded with Red and Golden Delicious apples was shipped from Yakima, Washington, to Portland, Oregon, and back to Yakima. The test pallet had the disclosed interlocking, self-supporting, molded pulp paper trays with contoured cups for holding each fruit. The system displaced the need for 49 fiberboard apple boxes, conventional trays, pads and polystyrene sheets. The incidence of physical damage to the fruit was minimal and the degree of damage severity was insignificant. Factors causing the minimal damage observed appear to be easily corrected.

The basis for the test was to determine if the new unconventional handling system, conceptually more cost effective, energy efficient and environmentally friendly, could provide fruit protection from the packinghouse to retailer without causing damage.

Handling perishable commodities has traditionally involved gathering a quantity of commodity into a manageable container that would protect the commodity. Over time apple handling evolved into a 40-42 pound telescoping fiberboard box that could be handled manually. The apple box with an assortment of adjunct, trays, pads, cells, wraps, polystyrene sheets and polyethylene box liners provided essential damage protection for cross country and global shipments. Increased volumes of fruit resulting from concentrated production centers of excellence and large retail chains dictated that stacks of boxes would be grouped and bound together on pallets for mechanized loading, transport and unloading. The disclosed system and trays eliminate the apple box and provide a basis for recycling and alternate uses for the trays. It also questions the need for some of the adjunct packaging materials.

In the test, a 40″×48″ standard pallet was loaded with the disclosed molded paper pulp trays. Trays were 20″×20″. Two or 3 trays of fruit weigh approximately one-half or three fourths the weight of a standard box and can be manually grasped and moved together as a single unit with ease. Contoured cups in each tray can hold 3 size ranges of 20 apples. Each tray served as a base for holding 20 apples and also as a cap for surrounding and covering the 20 apples in the tray below. There are multiple potential advantages that affect the grower, the packer, the shipper, the retailer and the environment. These include:

1. Elimination of box and materials costs.

$51.50 per box

$73.50 per pallet (49 boxes per pallet)

$1,500 per load (1000 boxes per load)

$97,500,000 per yr. (WA apple industry annual production)

2. Potentially lower commodity losses;

3. Potentially less litigation;

4. Elimination of inventory space required for boxes and other materials;

5. Reduced waste disposal and recycling costs at retail;

6. Reduced pallet and truckload weights for equivalent fruit quantities yielding increased load capacity or reduced libel consumption;

7. Conservation of energy consumed in manufacture of unnecessary items;

8. Reduction in biomass removal and greater preservation of natural resources; and

9. Potential for recycling and alternate end uses at retail.

Over packaging is a recognized adversary of The environment. Less packaging translates into less pollution, less land taken for landfills and less strain on the ecology. It is estimated that one tree is required for 100 pounds of packaging.

The test was designed to identify any and all damage occurring while fruit was held in the disclosed trays. Preparing a conventional pallet with the disclosed trays for inclusion in a normal load and documenting all detectable physical damage marks that occurred during shipment accomplished this.

At departure time, test fruit were inspected and all points where damage had previously occurred were circled. The same fruit were inspected again after arrival at destination and all new damage marks detected were recorded. Fruit were shipped from Yakima, Wash., to Sunnyside, Wash., to Portland, Oreg., to Sunnyside, Wash., and then returned to Yakima for final inspection.

The test shipment consisted of Washington apples on standard 40″×48″ pallets. There were 7 boxes on each layer and 7 layers on each pallet. Each pallet required 4,312 apples, 49 boxes (49 fiberboard cartons), 49 pads and 196 molded pulp paper frays. Cells, individual paper wraps, polystyrene sheets and polyethylene box liners may have been used in some packages.

The test pallet required approximately the same number of fruits, specially designed MS trays, but no fiberboard boxes, pads, wraps or separation sheets. Trays were 20″×20″ and molded from pulp paper. They were made to be self-supporting and interlocking. Four tiers of 39 trays were stacked on a 40″×48″ pallet. This left an 8″ center lane across the pallet. The center lane space was filled with 12 sets of 3 trays each by turning each set vertically and placing the sets in 2 stacks 4 high.

Size 88 Extra Fancy Red and Golden Delicious apples from Controlled Atmosphere storage were individually removed from packed boxes, inspected and transferred to the disclosed trays. All fruit were inspected as they were transferred, but in order to more precisely assess any possible damage associated with the system the equivalent of 10 boxes of size 80 apples (800 fruits) were inspected minutely and marked for any surface indentation, bruise, discoloration, spot, mark or blemish that could be attributed to physical damage, before and after shipping. The marking procedure consisted of circling damage marks on each apple with a marking pen before placing it in a tray. For minute inspection of specific effects, groups of 3 to 6 trays were placed randomly and at top, center and bottom positions within statics for subsequent fruit damage detection. The pre-shipment damage marks were minor and did not disqualify any of the fruit from meeting the Extra Fancy grade standard. Mold imperfections left pronounced burrs or mold marks in the cups of all the trays. These were all filed smooth to remove the burrs, except for those trays that required burrs be present to measure the burr effect. The test pallet was shipped in a standard load from Yakima, Washington, to Portland, Oregon, where it was off loaded and then returned to Yakima.

The special treatment effects studied were:

Effect on Variety: Red Delicious vs. Golden Delicious

Effect of position in pallet stack: Bottom vs. Center vs. Top

Effect of burrs in cup molds: Present vs. Removed

Effect of fruit position in fray: Calyx Up vs. Down

Effect of tray orientation on pallet: Vertical vs. Horizontal

Effect of extra protection: Paper wraps vs. No Wraps

Trays were stacked on the pallet as they were filled. The stacks were straight and vertical when the pallet was finished. The pallet had a slatted board surface. Materials to strap the pallet were not available at that time, as workers bad departed. By the next morning edges of some of the base trays had settled into the recesses between the slats causing the stacks to severely tip from vertical. Applying corner braces and strapping over and around the pallet straightened the pallet. The pallet was initially loaded in the front of the truck.

The loaded truck was then sent to Sunnyside, where the pallet was removed and wrapped in film. It was reloaded at the back of the load where it would receive more road vibration. The load was unloaded in Portland, but the test pallet was retained and reloaded to The front for the return to Sunnyside and Yakima. Upon return, the pallet was disassembled and fruit were individually removed from the trays for inspection.

The bulk of the pallet consisting of unmarked fruit was subjectively evaluated for damage in transit. Damage opinion such as would be formed by the retailer was obtained by inspection of this fruit. In addition, the 800 individually marked fruit were reexamined minutely and any new marks were circled with a different colored marking pen. Evidence for damage incurred in transit was obtained from the number of new marks on individual apples after return to Yakima.

Upon return to Yakima the test pallet was disassembled and inspected. Of the 800 fruits pre-marked for possible damaged spots, individual fruits ranged from 0 to 9 points with damage prior to shipment. When reexamined at Yakima after shipment for new damage marks there was no increase in range of points. Damage due to the test shipment was minimal and far less than incurred prior to the test. The results of this test indicate there is nothing to preclude abandoning the traditional telescoping apple box and adopting the disclosed invention. The film wrap had markedly improved the stability of the pallet. Some compression of trays was evident where a portion of a base tray bad slipped into the recess between top slats on the pallet. However, fruit within the compressed trays did not show detectable damage due to compression. There was also a broken corner and evidence that forks of a fork lift had hit trays, marking some fruit. Even so, damage injury was localized, relatively minor and is included in the detectable damage mark data.

The general inspection of all the fruits on the pallet revealed no damage that stood out or disqualified the load from meeting grade standards after arrival at final destination. The influence of variety and the effect of the tray position on Red and Golden Delicious developing detectable marks are shown in Table 1.

TABLE 1
Effect of Annie Variety & Pallet Tray Position on Detectable
Damage Marks

| Tray | | Red | | Total/Pos | Ave/Tray | Ave % |
|---|---|---|---|---|---|---|
| Position | Tray # | Del | Gold Del | Marked | Marked | Marked |
| Bottom | 1 | 0 | 2 | — | — | — |
| Bottom | 2 | 2 | 4 | 8 | 2 | 0.10 |
| Center | 1 | 0 | 0 | — | — | — |
| Center | 2 | 0 | 0 | 0 | 0 | 0 |
| Top | 1 | 2 | 0 | — | — | — |
| Top | 2 | 0 | 1 | 3 | 0.75 | 0.04 |
| Total # | — | 4 | 7 | 11 | — | — |
| Ave/Tray | — | 0.67 | 1.17 | — | 0.91 | — |
| Ave % | — | 0.03 | 0.06 | — | — | 0.05 |

Of the number of fruit with detectable damage after shipping, Table 1 shows that Golden Delicious was nearly twice as vulnerable as Red Delicious, but only about 1 apple per tray developed a detectable mark. Only 0.03% and 0.06% of the apples developed detectable marks due to the test shipment. This contrasts with up to 9 marks per apple and nearly 100% with marks present before shipping. Apples on trays in the center of the stack developed no marks. Fruit near the top of the pallet developed fewer marks than fruit near the bottom of the stack. The effect of minor rough or sharp burrs in the cups on producing detectable damage is shown in Table 2.

TABLE 2
Effect of Burrs on Trays to Incidence of Detectable Marks on
Fruit

| Burrs on | | Red | | Total P-R | Ave/Tray | Ave % |
|---|---|---|---|---|---|---|
| Trays | Tray # | Del | Gold Del | Marked | Marked | Marked |
| Present | 1 | 1 | 4 | — | — | — |
| Present | 2 | 0 | 1 | 6 | 1.5 | 0.08 |
| Removed | 1 | 0 | 0 | — | — | — |
| Removed | 2 | 0 | 12 | 12 | 6.0 | 0.3 |
| Total # | — | 1 | 17 | 18 | — | — |
| Ave/Tray | — | 0.25 | 4.25 | — | 4.5 | — |
| Ave % | — | 0.01 | 0.21 | — | — | 0.22 |

Burrs on the trays appear to have had no influence on damage marks due to material left in the trays due to the mold. Golden Delicious fruit in tray number 2 were at the bottom of the stack next to the pallet. This tray had been broken by contact with a forklift, which caused the high number of damage marks on adjacent fruit. Excluding the broken tray, the percentage of detectable fruit markings was insignificant. Even with the broken tray, the marking was negligible and would have no negative commercial significance. The effect of paper wraps on detectable marks is shown in Table 3.

TABLE 3
The Effect of Paper Wraps on Incidence of Detectable Damage
Marks

| | | Gold | | |
|---|---|---|---|---|
| Protection | Tray # | Del | Ave/Tray Marked | Ave % Marked |
| Wrapped | 1 | 1 | — | — |
| Wrapped | 2 | 8 | 4.5 | 0.23 |
| Not Wrapped | 1 | 1 | — | — |
| Not Wrapped | 2 | 4 | 2.5 | 0.06 |
| Total | — | 14 | 3.5 | 0.18 |

The paper wraps did not appear to provide any additional protection from tilt marking and may have reduced cup space, which indirectly augmented detectable damage. The effect of fruit position is given in Table 4.

TABLE 4
The Effect of Fruit Position on Incidence of Detectable Damage
Marks

| | | Red | | |
|---|---|---|---|---|
| Fruit Position | Tray # | Del | Ave/Try Marked | Ave % Marked |
| Calyx Down | 1 | 1 | — | — |
| Calyx Down | 2 | 0 | 0.5 | 0.03 |
| Calyx Up | 1 | 0 | — | — |
| Calyx Up | 2 | 0 | 0 | 0.0 |
| Total | — | 1 | 0.25 | 0.01 |

Fruit position had no effect on detectable damage marks. The unique contour of the cups and caps provide excellent protection, but also provide greater latitude, within the same tray, for maintaining protection of diverse sizes and shapes. The influence of the necessary vertical orientation of the center lane of trays is shown in Table 5.

TABLE 5
The Effect of Tray Orientation on Incidence on Detectable Dantane
Marks

| Tray | Tray | | | | Ave/Tray | Ave % |
|---|---|---|---|---|---|---|
| Orientation | # | Red Del | Gold Del | Total | Marked | Marked |
| Horizontal | 1 | 0 | 1 | 1 | — | — |
| Horizontal | 2 | 1 | 4 | 5 | — | — |
| Horizontal | 3 | 0 | 0 | 0 | 6 | 0.05 |
| Vertical | 1 | 2 | 3 | 5 | — | — |
| Vertical | 2 | 1 | 3 | 4 | — | — |
| Vertical | 3 | 1 | 5 | 6 | 15 | 0.13 |
| Total | — | 5 | 16 | 21 | — | |
| Ave/Tray | — | 0.83 | 2.67 | 1.75 | — | — |
| Ave % | — | 0.04 | 0.13 | 0.09 | — | 0.09 |

The vertical trays were inserted between the stacks in order to fill the space and build a more rigid, compact pallet load. Although marking was very minor it appears that the fruit do not get equal protection by vertical orientation.

The disclosed tray for moving apples was tested in a standard interstate shipment. The principal concern was if elimination of the apple box would result in damage that would reduce the grade standard or consumer appeal in any way. This concern was overcome by the test. The damage level was so low as to call any visible point of contact a “detectable damage mark” and not damage. Any depression, line, spot or color, no matter how small, which could be detected on the surface of the fruit against the normal background color and could be attributed to physical damage, was classed as a damage mark. It is highly unlikely that a Federal-State Inspector would list any of the marks counted here as damage. The incidence of such marks was also extremely low. Statistical analyzes for significant differences were not made. Although some differences between treatments may have been statistically significantly different, the incidence was too low to have practical significance. The test shipment of interlocking, self-supporting trays successfully eliminated the need for the traditional apple box. The shipment was made without causing injury or damage or contributing to existing damage marks that would affect or reduce grade in any way.

Over packing is a common practice in packaging of many of today's products. It increases costs throughout The market chain and has many adverse implications for the environment. The disclosed test demonstrated that special molded trays could eliminate the need for conventional apple boxes in interstate truck transport without contributing to damage causing grade loss. Elimination of apple boxes would result in major cost savings across the Washington Apple Industry.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible which employ the same inventive concepts as described above. Therefore, the invention is not to be limited except by the claims that follow.

I claim:

1. A method for optimizing the distribution of perishable fruit by a broker, comprising the steps of:
e. providing a fruit selection criteria database, the selection criteria database further comprising transportation requirements and time constraints information for the perishable fruit,
f. providing a fruit distribution channels database, the distribution channels database further comprising current information concerning availability of distribution channels,
g. providing a fruit sellers database,
h. providing a fruit consumers database,
i. providing a fruit packaging materials database, the fruit packaging materials database further comprising data concerning fruit packaging materials sellers and buyers,
j. selecting the fruit to be distributed,
k. selecting a seller of the selected fruit from the fruit sellers database, said seller having a geographic location,
l. selecting a buyer of the selected fruit from the fruit consumers database, said buyer having a geographic location,
m. selecting a packaging material from the fruit packaging materials database, wherein the packaging material is optimally suited to transport the selected fruit provided by the selected fruit seller, and wherein the selected packaging materials comprise interlocking trays that do not require outer cartons,
n. selecting a source for the selected packaging material from the fruit packaging materials database,
o. selecting an end destination for the selected packaging material from the fruit packaging materials database,
p. co-ordinating delivery of the selected packaging material to the seller of the selected fruit for packaging of the fruit,
q. selecting a mode of transportation from the fruit distribution channels database that will optimally transport the selected fruit in the selected packaging material from the seller of the selected fruit and transport them to the geographic region of the buyer of the selected fruit,
r. co-ordinating the transportation of the selected fruit in the selected packaging material from the seller of the selected fruit and transport them to the geographic region of the buyer of the selected fruit,
s. separating the selected fruit from the selected packaging material for delivery of the selected fruit to the selected buyer of the selected fruit and for delivery of the selected packaging material to the end destination for the selected packaging material,
t. monitoring the quality of the selected fruit and the selected packaging material at the separation of the selected fruit from the selected packaging material,
u. delivering the selected fruit to the buyer of the selected fruit,
v. delivering the selected packaging material to the end destination for the selected packaging material, and
w. processing the selected packaging material.

2. The method for optimizing the distribution of perishable fruit by a broker of claim 1, wherein the step of selecting a source for the selected packaging material from the fruit packaging materials database further comprises the step of selecting a packaging material seller to provide the packaging material.

3. The method for optimizing the distribution of perishable fruit by a broker of claim 1, wherein the step of selecting a source for the selected packaging material from the fruit packaging materials database further comprises the step of selecting a packaging material from an inventory of packaging material.

4. The method for optimizing the distribution of perishable fruit by a broker of claim 1, wherein the step of selecting an end destination for the selected packaging material further comprises the step of selecting a packaging material buyer.

5. The method for optimizing the distribution of perishable fruit by a broker of claim 1, wherein the selected packaging material for the interlocking trays is reusable.

6. The method for optimizing the distribution of perishable fruit by a broker of claim 1, wherein the selected packaging material is optimally suited to transport the selected fruit provided by the seller of the selected fruit.

7. The method for optimizing the distribution of perishable fruit by a broker of claim 6, wherein the selected packaging material for the interlocking trays comprises a reusable material.

8. The method for optimizing the distribution of perishable fruit by a broker of claim 1, wherein the step of selecting an end destination for the selected packaging material further comprises the step of selecting an inventory for suspended packaging material.

9. A method for optimizing the distribution of perishable products, comprising the steps of:
a. providing a perishable products selection criteria database, the selection criteria database further comprising transportation requirements information for the perishable products and perishable products distribution information and distribution channels distribution information,
b. providing a perishable products database, the perishable products database further comprising perishable products seller and consumer information,
c. providing a perishable products packaging database for perishable products packaging that does not require an outer carton, the perishable products packaging database further comprising data concerning perishable products packaging sellers and end destinations,
d. selecting the perishable products to be distributed,
e. selecting a seller of the selected perishable products from the perishable products database,
f. selecting a buyer of the selected perishable products from the perishable products database,
g. selecting packaging for the perishable products from the perishable products packaging database, wherein the packaging is optimally suited to transport the selected perishable products,
h. selecting the seller of the selected packaging from the perishable products packaging database,
i. selecting an end destination for the selected packaging from the perishable packaging database, wherein the end destination is optimally suited to the selected buyer of the perishable products,
j. co-ordinating delivery of the selected packaging to the seller of the selected perishable products for packaging of the perishable products,
k. selecting transportation from the perishable products selection criteria database that will optimally transport the selected perishable products in the selected packaging to the buyer of the selected perishable products,
l. co-ordinating the transportation of the selected perishable products in the selected packaging to the selected buyer of the selected perishable products,
m. separating the selected perishable products from the selected packaging for delivery of the selected perishable products to the selected buyer of the selected perishable products and for delivery of the selected packaging to the end destination for the selected packaging,
n. monitoring the quality of the selected perishable products and the selected packaging at the step of separating the selected perishable products from the selected packaging,
o. delivering the selected perishable products to the buyer of the selected perishable products,
p. delivering the selected packaging to the end destination for the selected packaging, and
q. processing the selected packaging.

10. The method for optimizing the distribution of perishable products of claim 9, wherein the step of selecting a source for the selected packaging from the perishable products packaging database further comprises the step of selecting a packaging seller.

11. The method for optimizing the distribution of perishable products of claim 9, wherein the perishable products packaging database further comprises an inventory of packaging material, and wherein the step of selecting a source for the selected packaging from the perishable products packaging database further comprises the step of selecting the packaging material from the inventory of packaging material.

12. The method for optimizing the distribution of perishable products of claim 9, wherein the step of selecting an end destination for the selected packaging further comprises the step of selecting a packaging buyer.

13. The method for optimizing the distribution of perishable products of claim 9, wherein the step of selecting an end destination for the selected packaging further comprises the step of selecting an inventory for suspended packaging material.

14. A method for optimizing the shipping of products, comprising the steps of:
a. providing a product selection criteria database, the selection criteria database further comprising transportation requirements information for the perishable products and product distribution channels information,
b. providing a product database, the product database further comprising product seller and consumer information,
c. providing a product packaging database, the product packaging database further comprising data concerning product packaging sellers and a product suspension database,
d. selecting the product to be distributed from the product database,
e. selecting a seller of the selected product from the product database,
f. selecting a buyer of the selected product from the product database,
g. selecting packaging for the product from the product packaging database, wherein the packaging is optimally suited to transport the selected product,
h. suspending the selected packaging in the selected packaging suspension database,
i. selecting an end destination for the selected packaging from the product packaging suspension database, wherein the end destination is optimally suited to the suspended selected packaging,
j. selecting transportation from the product selection criteria database that will optimally transport the selected product in the selected packaging to the buyer of the selected product,
k. delivering the selected product to the buyer of the selected product, and
l. delivering the selected packaging to the end destination for the selected packaging.

15. The method for optimizing the distribution of products of claim 14, wherein step of optimizing selecting an end destination for the selected packaging from the product packaging suspension database further comprises suspending the product packaging until a product packaging buyer is selected.

16. The method for optimizing the distribution of products of claim 14, wherein step of optimizing selecting an end destination for the selected packaging from the product packaging suspension database further comprises placing the product packaging in a suspended product packaging inventory until the optimal end destination is selected.
